(19) United States
(12) Patent Application Publication
(10) Pub. No.: US 2001/0030685 A1
(43) Pub. Date: Oct. 18, 2001

(54) Method and apparatus for digital film processing using a scanning station having a single sensor

(76) Inventors: Stephen P. Darbin, Austin, TX (US); Robert S. Young JR., Austin, TX (US)

Correspondence Address: DINSMORE & SHOHL, LLP, 1900 CHEMED CENTER, 255 EAST FIFTH STREET, CINCINNATI, OH, 45202, US

(21) Appl. No.: 09/740,699

(22) Filed: Dec. 18, 2000

Related U.S. Application Data
(60) Provisional application No. 60/174,189, filed on Dec. 30, 1999.

(51) Int. Cl. H04N 5/253

(52) U.S. Cl. 348/96

(57) ABSTRACT

A digital film processing system and method which utilizes a single imaging station having a single sensor unit. During a first scanning, radiation is applied to the front surface of a frame of developing film and the radiation reflected from the front surface of the film is sensed using a single sensor unit. The film is then flipped or rotated either manually or automatically. During a second scanning, radiation is then applied to the back surface of the same frame of the developing film, and the radiation reflected from the back surface of the film is sensed using the single sensor unit. During another scanning, either before or after the film is flipped, radiation is transmitted through the same frame of the developing film and the transmitted radiation is sensed by the single sensor unit. Then, a single digital image file for the frame is created from the three scannings.

This application claims the benefit of U.S. Provisional Application No. 60/174,189 filed Dec. 30, 1999, the entire disclosure of which is hereby incorporated herein by reference.

### TECHNICAL FIELD

The present invention relates generally to digital film processing, and more particularly to a method and apparatus for scanning a film frame multiple times using a single scanning station which has a single sensor unit configured to scan one side of the film.

### BACKGROUND OF THE INVENTION

Color photographic film generally comprises three layers of light sensitive material that are separately sensitive to red, green, and blue light. During conventional color photographic film development, the exposed film is chemically processed to produce dyes in the three layers with color densities directly proportional to the blue, green and red spectral exposures that were recorded on the film in response to the light reflecting from the photographed scene. Yellow dye is produced in the top layer, magenta dye in the middle layer, and cyan dye in the bottom layer, the combination of the produced dyes revealing the latent image. Once the film is developed, a separate printing process can be used to record photographic prints, using the developed film and photographic paper.

In contrast to conventional film development, digital film development systems, or digital film processing systems, have been proposed. One such system involves chemically developing exposed film to form scene images comprised of silver metal particles or grains in each of the red, green, and blue recording layers of the film. Then, while the film is developing, it is scanned using electromagnetic radiation, such as light with one predominant frequency, preferably in the infrared region. In particular, as the film develops in response to chemical developer, a light source is directed to the front of the film, and a light source is directed to the back of the film. Grains of elemental silver developing in the top layer (e.g., the blue sensitive layer) are visible from the front of the film by light reflected from the front source; however, these grains are substantially hidden from the back of the film. Similarly, grains of elemental silver developing in the bottom layer (e.g., the red sensitive layer) are visible from the back of the film by light reflected from the back source; however these grains are substantially hidden from the front. Meanwhile, grains of elemental silver in the middle layer (e.g., the green sensitive layer) are substantially hidden from the light reflected from the front or back; however, these grains are visible by any light transmitted through the three layers, as are those grains in the other two layers. Thus, by sensing, for each pixel location, light reflected from the front of the film, light reflected from the back of the film, and light transmitted through the film, three measurements can be acquired for each pixel. The three measured numbers for each pixel can then be solved for the three colors to arrive at three color code values for each pixel, and the plurality of colored pixels can then be printed or displayed to view the image.

If desired, such scanning of each frame on the film can occur at multiple times during the development of the film. Accordingly, features of the frame which may appear quickly during development can be recorded, as well as features of the frame which may not appear until later in the film development. The multiple digital image files for each frame can then be combined to form a single enhanced image file.

While such multiple scanning can be conducted through the use of multiple scanning stations, such a system requires redundant hardware, which can add to the cost, complexity, and size of the system. One alternative is that the film could be moved in forward and reverse through a single scanning station. However, such a solution involves time in switching from forward to reverse (in addition to associated equipment), as well as the complexity in aligning and combining multiple digital image files, some of which were taken during forward movement and some of which were taken during reverse movement. Accordingly, it is desirable to provide a digital film processing system with reduced expense, size, and/or complexity.

### SUMMARY OF THE INVENTION

According to an embodiment of the invention, a method and apparatus for creating a digital image file using a single sensor unit is provided. A first side of a medium is scanned using a single imaging station having one sensor unit to create a first digital image file representing a source image on the medium. An opposite side of the medium is scanned using the single imaging station to create a second digital image file representing the source image. The first and second digital images are combined to create a single enhanced digital image which represents the image. The medium can comprise developing film, and the imaging station can comprise a front source to apply radiation to one side of the film, a back source to apply radiation to an opposite side of the film, and a single sensor unit configured to sense radiation supplied by the sources and reflected from and transmitted through the film. In this embodiment, after travel through the imaging station, the film can be rotated and re-scanned by the imaging station such that opposing sides of the film face the sensor unit during the consecutive scannings. The rotation can be caused by introducing a twist into the film, the twist being located past the imaging station such that the film flips after it passes the imaging station. The film is then recirculated through the imaging station such that an opposite side of the film faces the single sensor unit during a subsequent scanning.

An advantage of at least one embodiment of the invention is that the size, cost, and/or complexity of a digital film development system is minimized.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

While the specification concludes with claims particularly pointing out and distinctly claiming the invention, it is believed that the same will be better understood from the following description taken in conjunction with the accompanying drawings in which like reference numerals indicate corresponding structure throughout the figures.

FIG. 1 is a perspective view of an exemplary digital film development system which can be used with the methods and apparatus of the present invention;

FIG. 2 illustrates the operation of the digital film development system of FIG. 1;

FIG. 3 is a side view of an exemplary modular digital film development system having multiple scanning stations or modules;

FIG. 4 is a side view of a digital film development system having minimal hardware, according to principles of the present invention;

FIGS. 5a and 5b illustrate an alternative digital film development method which utilizes minimal hardware, according to principles of the present invention; and

FIGS. 6a, 6b, and 6c illustrate an alternative digital film development method which utilizes minimal hardware, according to principles of the present invention.

### DETAILED DESCRIPTION OF EXEMPLARY EMBODIMENTS

In general, the present invention relates to a digital film processing system and method which has lower cost, complexity, and/or size when compared to other digital film processing systems and methods which utilize multiple imaging stations and/or multiple sensors. During a first scanning, radiation is applied to the front surface of a frame of developing film and the radiation reflected from the front surface of the film is sensed using a single sensor unit. The film is then flipped or rotated either manually or automatically. During a second scanning, radiation is then applied to the back surface of the same frame of the developing film, and the radiation reflected from the back surface of the film is sensed using the single sensor unit. During another scanning, either before or after the film is flipped, radiation is transmitted through the same frame of the developing film and the transmitted radiation is sensed by the single sensor unit. Then, a single digital image file for the frame is created from the front reflected radiation, the back reflected radiation, and the transmitted radiation. Using the same method and system, additional digital image files can be created for the same image at other film development times, and all of these files can be combined to create a single enhanced image file which includes features which appear on the film during various development times.

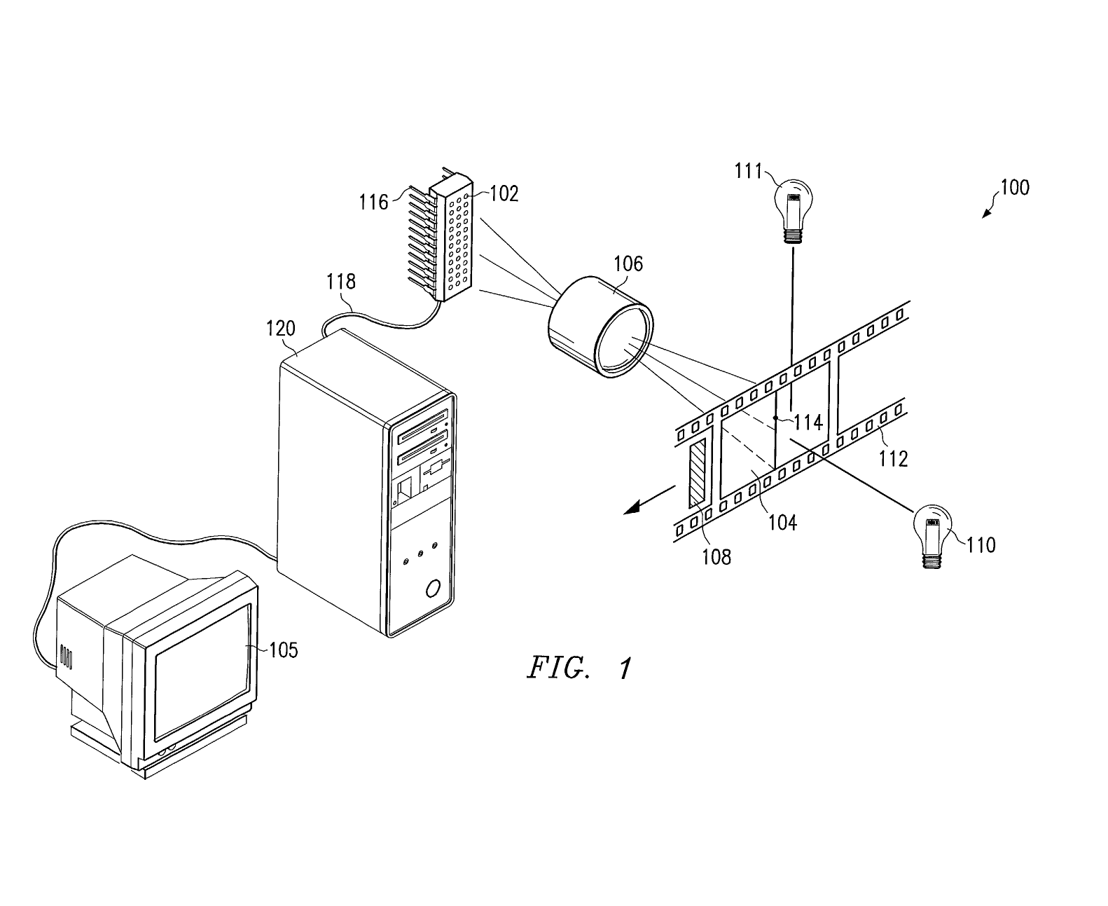

FIG. 1 shows an improved digital film processing system 100. The system operates by converting electromagnetic radiation from an image to an electronic (digital) representation of the image. The image being scanned is typically provided on a photographic film media 112 which is being developed using chemical developer. In many applications, the electromagnetic radiation used to convert the image into a digital representation is infrared light; however, visible light, microwave and other suitable types of electromagnetic radiation may also be used to produce the digitized image. The scanning system 100 generally includes a number of optic sensors 102, which measure the intensity of electromagnetic energy passing through or reflected by the developing film 112. The source of electromagnetic energy is typically a light source 110 which illuminates the film 112 containing the scene image 104 and 108 to be scanned, which are forming on the film during the film development. Radiation from the source 110 may be diffused or directed by additional optics such as filters or waveguides (not shown) and/or one or more lenses 106 positioned between the sensor 102 and the film 112 in order to illuminate the images 104 and 108 more uniformly.

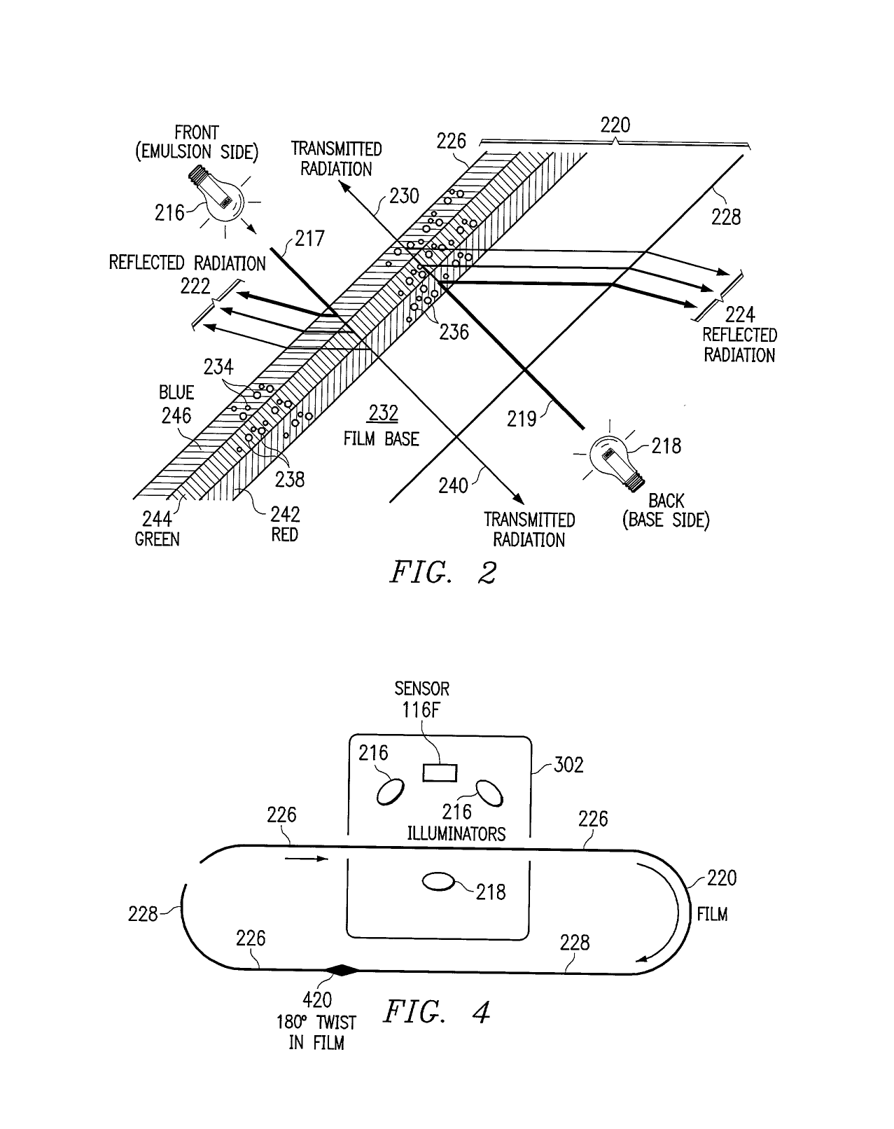

Source 110 is positioned on the side of the film 112 opposite the optic sensors 102. This placement results in sensors 102 detecting radiation emitted from source 110 as it passes through the images 104 and 108 on the film 112. Another radiation source 111 can be placed on the same side of the film 112 as the sensors 102. When source 111 is activated, sensors 102 detect radiation reflected by the images 104 and 108. This process of using two sources positioned on opposite sides of the film being scanned is described in more detail below in conjunction with FIG. 2.

The optic sensors 102 are generally geometrically positioned in arrays such that the electromagnetic energy striking each optical sensor 102 corresponds to a distinct location 114 in the image 104. Accordingly, each distinct location 114 in the scene image 104 corresponds to a distinct location, referred to as a picture element, or “pixel” for short, in a scanned image, or digital image file, which comprises a plurality of pixel data. The images 104 and 108 on film 112 can be sequentially moved, or scanned relative to the optical sensors 102. The optical sensors 102 are typically housed in a circuit package or unit 116 which is electrically connected, such as by cable 118, to supporting electronics for storage and digital image processing, shown together as computer 120. Computer 120 can then process the digital image data and display it on output device 105. Alternatively, computer 120 can be replaced with a microprocessor or controller and cable 118 replaced with an electrical connection.

Optical sensors 102 may be manufactured from different materials and by different processes to detect electromagnetic radiation in varying parts and bandwidths of the electromagnetic spectrum. For instance, the optical sensor 102 can comprise a photodetector that produces an electrical signal proportional to the intensity of electromagnetic energy striking the photodetector. Accordingly, the photodetector measures the intensity of electromagnetic radiation attenuated by the images 104 and 108 on film 112.

The embodiments of the present invention described in detail below can use duplex film scanning. As shown in FIG. 2, duplex scanning refers to using a front source 216 and a back source 218 to scan a developing film 220 with radiation 217 and 219 respectively. The applied radiation 217 and 219 results in reflected radiation 222 from the front 226 and reflected radiation 224 from the back 228 of the film 220, as well as transmitted radiation 230 and 240 that passes through all layers of the film 220. While the sources 216, 218 may emit a polychromatic light (i.e., multi-frequency light), the sources 216, 218 can emit monochromatic light, such as infrared light for example. The resulting radiation 222, 224, 240, and 230 are referred to herein as front, back, front-through and back-through, respectively, and are further described below.

In FIG. 2, separate color layers are viewable within the film 220 during development of the red layer 242, green layer 244 and blue layer 246. More specifically, over a clear film base 232 are three layers 242, 244, 246 sensitive separately to red, green, and blue light, respectively. These layers are not physically the colors; rather, they are sensitive to these colors. In conventional color film development, the blue sensitive layer 246 would eventually develop a yellow dye, the green sensitive layer 244 a magenta dye, and the red sensitive layer 242 a cyan dye.

During chemical development of the film 220, such as by using a developer, layers 242, 244, and 246 are opalescent. Dark silver grains 234 developing in the top layer 246, (the blue source layer), are visible from the front 226 of the film by radiation 222, and slightly visible from the back 228 because of the bulk of the opalescent developer emulsion. Similarly, grains 236 in the bottom layer 242 (the red sensitive layer) are visible from the back 228 by reflected radiation 224, but are much less visible from the front 226. Grains 238 in the middle layer 244, the green sensitive layer, are only slightly visible to reflected radiation 222, 224 from the front 226 or the back 228. However, they are visible along with those in the other layers by transmitted radiation 230 and 240. By sensing radiation reflected from the front 226 and the back 228 as well as radiation transmitted through the developing film 220 from both the front 226 and back 228 of the film, each pixel in the film 220 yields four measured values, that may be mathematically solved for the three colors, red, green, and blue, closest to the original scene. For instance, a matrix transformation may be utilized as described in U.S. Pat. No. 5,519,510, the entire disclosure of which is hereby incorporated herein by reference.

The front signal records the radiation 222 reflected from the illumination sources 216 in front of the developing film 220. The set of front signals for an image is called the front channel (F). The front channel principally, but not entirely, records the attenuation in the radiation from the source 216 due to the silver metal particles 234 in the top-most layer 246, which is the blue recording layer. The front channel also records some attenuation in the radiation which is due to silver metal particles 236, 238 in the red and green layers 242, 244.

The back signal records the radiation 224 reflected from the illumination sources 218 in back of the developing film 220. The set of back signals for an image is called the back channel (B). The back channel principally, but not entirely, records the attenuation in the radiation from the source 218 due to the silver metal particles 236 in the bottom-most layer 242, which is the red recording layer. Additionally, there is some attenuation which is recorded by the back channel which is due to silver metal particles 234, 238 in the blue and green layers 246, 244.

The front-through signal records the radiation 230 that is transmitted through the developing film 220 from the illumination source 218 in back of the film 220. The set of front-through signals for an image is called the front-through channel (T). Likewise, the back-through signal records the radiation 240 that is transmitted through the developing film 220 from the source 216 in front of the film 220. The set of back-through signals for an image is called the back-through channel (T). The front source 216 is can be energized at a first instance in time to record the front signal and back-through signal, and the back source 218 can be energized at a separate instance in time to record the back signal and front-through signal. Both through channels record essentially the same image information since they both record attenuation of the radiation 230, 240 due to the silver metal particles 234, 236, 238 in all three red, green, and blue recording layers 242, 244, 246 of the film 220. Accordingly, one of the through channel signals can be disregarded.

Several image processing steps can then be used to convert the illumination source radiation information for each channel (B, F, and T) to the red, green, blue values similar to those procured by conventional scanners for each spot on the film 220. These steps are conducted because the silver metal particles 234, 236, 238 that form during the development process are not spectrally unique in each of the film layers 242, 244, 246. These image processing steps are not performed when conventional scanners are used to scan film after it has been developed, because the dyes which are formed with conventional chemical color development of film make each film layer spectrally unique. However, just as with conventional scanners, once red, green, and blue values are derived for each image, further processing of the red, green, and blue values is usually done to enhance, manipulate, display, and/or print the image.

The digital film development system shown in FIGS. 1 and 2 can produce multiple digital image files for the same frame at different film development times, each image file having back, front, and through values which are created using the duplex scanning method described above. It is desirable to create multiple duplex-scanned image files for the same frame at separate development times so that features of the image which appear at various development times can be recorded. During the film development process, the highlight areas of the image (i.e., areas of the film which were exposed to the greatest intensity of light) will develop before those areas of the film which were exposed to a lower intensity of light (such as areas of the film corresponding to shadows in the original scene). Thus, a longer development time will allow shadows and other areas of the film which were exposed to a low intensity of light to be more fully developed, thereby providing more detail in these areas. However, a longer development time will also reduce details and other features of the highlight areas of the image. Thus, in conventional film development, one development time must be selected and this development time is typically chosen as a compromise between highlight details, shadow details and other features of the image which are dependent on the duration of development. Scanning this developed film image using a conventional film scanner will not revive any of these details which are development time dependent. However, in the digital film development process of FIGS. 1 and 2, such a compromise need not be made, as digital image files for the same image can be created at multiple development times while the film develops, and these multiple images can be combined to produce an enhanced image.

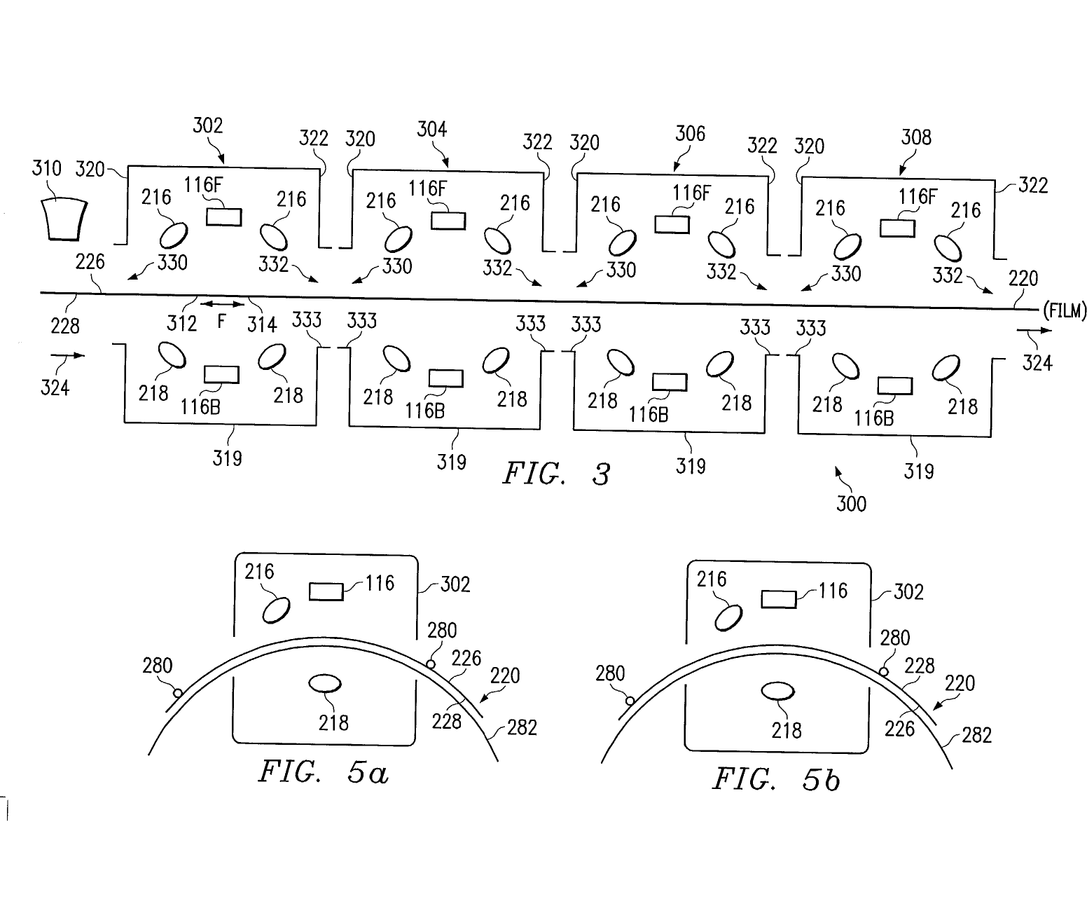

In particular, as shown in FIG. 3, multiple separable scanning modules (i.e., imaging stations or scanning stations) 302, 304, 306, and 308 can be utilized to produce the multiple digital image files of the same image at separate development times. Each station 302,304,306, and 308 in the digital processing system 300 includes a front source 216, a back source 218, a front sensor 116F, and a back sensor 116B, which operate using the deuplex scanning method as described above with respect to FIGS. 1 and 2. In particular, with reference to FIGS. 2 and 3, the front sensor 116F detects reflected radiation 222 (generated by front source 216), and also transmitted radiation 230 (generated by the back source 218). Likewise, the back sensor 116B detects the reflected radiation 224 (generated by back source 218), and the transmitted radiation 240 (generated by the front source 216).

Referring now solely to FIG. 3, the stations 302, 304, 306, and 308 are serially connected to form the system 300. This exemplary digital film processing system 300 has a pipeline configuration. Thus, the film travels in the direction 324 from the first station 302, to the second station 304, to the third station 306, to the fourth station 308.

The film 220 can be transported as a continuous strip through the stations 302, 304, 306, and 308 by a suitable film transportation or conveyance system. Because of the time lag between transportation of an image on the film 220 between the stations 302, 304, 306, and 308, each station scans and records a digital image file of a given image at a different development time during the development of the film.

For example, each image or frame on the film, such as frame F which resides between the points 312 and 314, could have developer applied thereto, such as by dispenser 310. The transportation system would then move the frame F to station 302, where a first digital image file is created, using two reflectance signals (a back reflectance signal and a front reflectance signal) and one transmission signal (a back-through signal or a front-through signal) as described above. The frame F would then be transported to station 304 where a second image file is created of the same frame, again using two reflectance signals and one transmission signal. However, because of the predefined time lag in transporting the frame F from the first station 302 to the second station 304, the frame would be scanned by the second station 304 at a later point in the development of the image on the frame F. Thus, some features of the image which might be appearing within the frame F during the development of the film 220 might be captured in the first data image file, but not in the second data image file, and vice versa.

The additional stations 306 and 308 can be connected into the system 300 to provide additional image data files for the frame F at additional development times of the frame. For example, after the second image data file is created for the frame F by the second station 304, a third image data file could be created for the frame F at a later development time by the third station 306 which would obtain two reflectance signals and one transmission signal. Similarly, a fourth image data file could be created by the fourth station 308 at the longest development time, also by obtaining two reflectance signals and one transmission signal. In this manner, four digital representations of the same frame image may be obtained by using deuplex scanning at different development times, such as at 25%, 50%, 75%, and 100% of the total development time, for example. These four digital representations may then be aligned and combined with one another (i.e., stitched together) to form an enhanced digital representation of the image. This digital representation may be viewed on a video monitor associated with a computer, or printed on a printer connected to computer (such as a laser printer or an ink jet printer) for instance.

As shown in FIG. 3, each station 302, 304, 306, and 308 can be separable from the system 300. Accordingly, although the system 300 is shown with four stations, the system can be easily provided with fewer than four or more than four stations as desired by the user. For instance, if the user desired a system with only three stations to save cost, the station 308 could be disconnected from the station 306 and removed from the system.

However, the system of FIG. 3 requires multiple scanning stations to take multiple images from the same frame at the various development times. In contrast, according to principles of the present invention and as shown in FIG. 4, a single scanning station 302 is provided to conduct the scanning of the film, rather than multiple scanning stations. Moreover, rather than having sensors positioned at opposite sides of the film 220, the single scanning station 302 includes a single sensor 116F positioned on one side of the film. In addition, the station 302 includes one or more front sources 216 and one or more back sources 218.

However, the duplex scanning process described above with respect to FIG. 2 requires sensing reflected radiation from both the top 226 and the bottom 228 of the film 220. Although the system in FIG. 4 has a single sensor 116F, it can sense reflected radiation from both the front and the back of the film by flipping or turning the film after it has been scanned on one side. In the exemplary embodiment of FIG. 4, this flipping of the film can be accomplished by placing a 180 degree twist (e.g., a Mobius twist) 420 in the film strip 220 at a point on the strip downstream from the sensor 116F. Accordingly, the film 220 will flip as it travels through the twist 420. The film can then be fed back through the sensor area, and the backside of the film will be scanned. Thus, a first side 226 of the film 220 faces the sensor unit 116F when the film initially travels through the station 302. Then, as the film 220 travels past the twist 420, it rotates 180 degrees. The film 220 is then fed back through the station 116F a second time, during which the opposite side 228 of the film faces the sensor unit 116F.

Thus, for each frame on the film 220, a first scan is made by the system of FIG. 4 when the front side 226 of the film faces the sensor 116F, and reflected and transmitted radiation levels for the front of the frame (the front signal and the front-through signal) are sensed by the sensor 116F and recorded in a first half file. The source 218 can be illuminated at a separate time than the source 216, so the sensor 116F can differentiate the reflected radiation from the transmitted radiation. Then, a second scan is made of the frame after the frame has passed through the Mobius twist 420. Accordingly, because the back side 228 of the film 220 will then be facing the sensor 116F, the sensor 116F will sense the reflected and transmitted radiation levels for the back of the frame (the back signal and back-through signals) and these will be recorded in a second half file. The first half file and second half files can then be combined to form one duplex digital image file for the frame. Other duplex digital image files may be created in a similar manner for the same frame at other film development times, and the multiple digital image files can then be stitched together to form a single enhanced image file. Accordingly, the first and subsequent duplex files for the first frame can be combined to create an enhanced file for the first frame, the first and subsequent duplex files for the second frame can be combined (stitched) to form an enhanced file for the second frame, and so on.

The first half file and the second half file can be recorded fairly close in time, such that minimal development changes occur to the frame between the creation of the two files. The type of chemical developer utilized can be adjusted to control the amount of development that takes place between scannings, as well as the timing of the development of the various layers of the film. Development times between the creation of multiple digital image files can be varied as desired, and as discussed above.

Accordingly, the system of FIG. 4 minimizes the hardware needed for the creation of digital image files in a digital film development process which uses duplex scanning. The system can also be utilized to maximize efficiency in any duplex-scanning device or process that scans both sides of a medium, such as in paper or film scanning devices and processes for example. One alternative to manipulating the film would be to rotate or otherwise move the sensor 116F to the back 228 of the film 220 for recording data therefrom. Thus, data from both the front and back of the film 220 can be recorded.

After all scans are taken for all frames, and all film development times, a new film strip to be developed can then be entered into the station 302 and the old strip removed. The film may be transported in any of a variety of manners, such as by using motors, belts, wheels, etc. As shown, the station 302 has a front source 216 and front sensor unit 116F, and a back source 218, which operate in a manner similar to the sources and sensors described above with respect to FIGS. 1-3. The sensor unit 116F can include a row of individual sensors such that rows or columns of each frame are scanned sequentially by moving the frame relative to the row of sensors. The accumulated data taken from the various rows or columns of the frame forms the digital image for that scan.

FIGS. 5a and 5b show alternatives to the system of FIG. 4. In FIG. 5a, the medium 220 is transported through the scanning station 302 during a first scanning in which the first surface 226 faces the sensor unit 116. Accordingly, during the first scanning, the single sensor unit 116 records radiation provided by source 216 and reflected from the surface 226 of the medium 220. The sensor 116 also can record radiation provided by source 218 and transmitted through the medium 220 from surface 228 through surface 226. The recording of the transmitted radiation can occur at a separate instance in time from the recording of the reflected radiation, in order to distinguish the two types of radiation.

Any of a variety of transportation mechanisms can be utilized to transport the medium 220 through the scanning station 302, such as roller devices 280 which contact and move the medium. A guide or support surface 282 can be provided to support and/or guide the medium as it travels. In one embodiment, the medium 220 is secured to a support surface 282 and the support surface is moved. For example, the medium could be supported on a wheel which is rotated.

After the first scanning, shown in FIG. 5a, the medium 220 is rotated or flipped. Accordingly, in FIG. 5b, the medium 220 is transported through the scanning station 302 during a second scanning in which the second surface 228, which is opposite the first surface 226, faces the sensor 116. Accordingly, during the second scanning, the single sensor unit 116 records radiation provided by source 216 and reflected from the surface 228 of the medium 220. The sensor 116 also can record radiation provided by source 218 and transmitted through the medium 220 from surface 226 through surface 228. The recording of the transmitted radiation can occur at a separate instance in time from the recording of the reflected radiation, in order to distinguish the two types of radiation. The data from the first and second one-sided scannings can then be combined to represent the image or images on the medium 220. By twisting or rotating the medium, each scanning records information from opposite sides of the medium (i.e., each scanning is one half of a duplex scan). As noted above, the medium 220 can comprise developing film, and that subsequent scannings can also be conducted at other development times to provide additional digital image data which can be combined with the first two scannings to produce a single enhanced file.

In order to flip or rotate the medium 220 between the configurations shown in FIGS. 5a and 5b, any of a variety of mechanisms and/or methods could be utilized. For instance, the medium 220 could be flipped or rotated manually. However, the medium 220 can also be flipped or rotated automatically. For example, after being transported through the scanning station 302 and scanned the first time, one edge of the medium could be contacted and rotated by a mechanical device until the medium has flipped 180 degrees. Alternatively, the medium could be guided through a twist by a rail or support surface. The rotated medium could then be re-sent through the scanning station 302 to conduct a second scanning with the sensor 116 facing its opposite side.

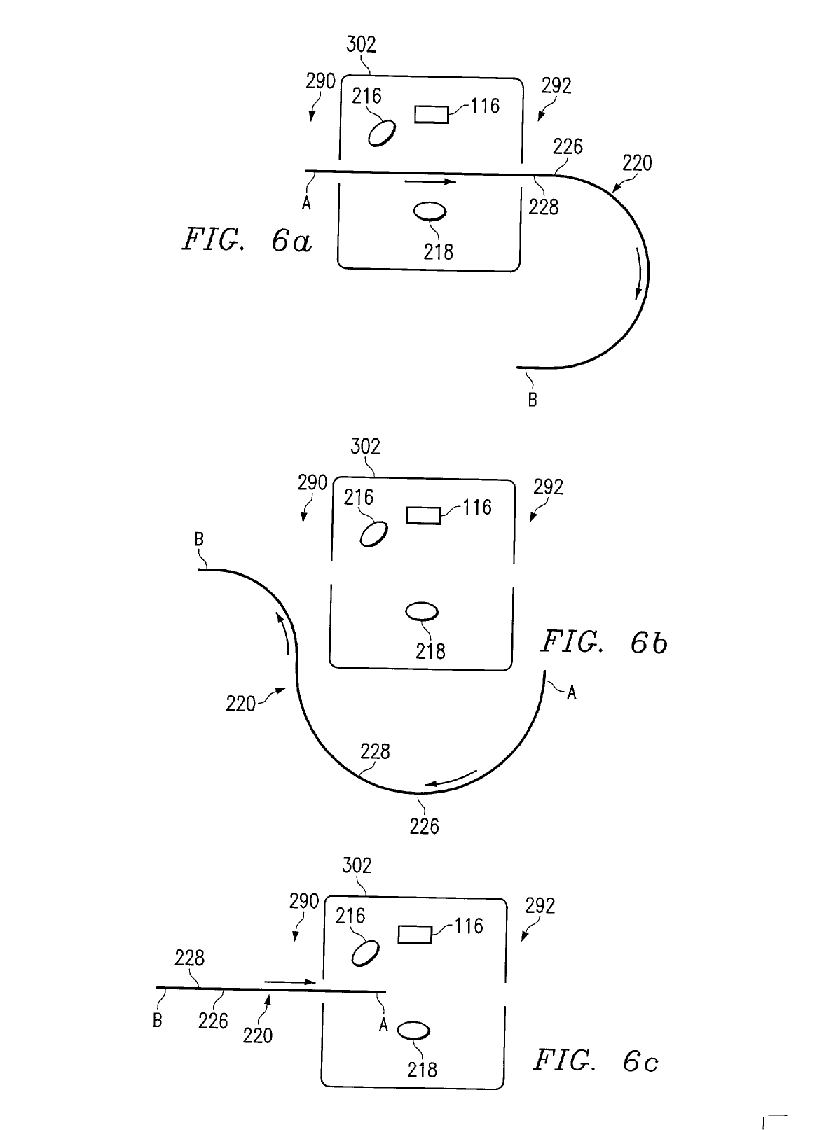

FIGS. 6a, 6b, and 6c illustrate another alternative system and method for scanning opposing sides of the medium 220 during consecutive scannings. In FIG. 6a, the medium 220 travels through the scanning station 302 such that the first side 226 of the medium faces the sensor unit 116 during the first scanning. During this scanning, the end B of the medium 220 is the leading edge of the medium 220 as it travels. After the first scanning, and as shown in FIG. 6b, the medium 220 continues to travel from the output side 292 of the station 302 to the input side 290 of the station in a re-circulating fashion. Then, during the second scanning, and as shown in FIG. 6c, the medium 220 is once again moved through the scanning station 302. During this scanning, the end A is the leading end of the medium 220 as it travels through the station 302, and the second side 228, which is opposite the side 226, faces the sensor 116 during the scanning.

For each source image on the medium 220, multiple digital images are created which correspond to the multiple scannings. Each of the digital images for a given source image records radiation reflected from the medium 220, and at least one of the digital images for the source image records radiation transmitted through the medium. The multiple digital images for each source image are then combined or stitched to create a single duplex digital image representing the source image.

The foregoing descriptions of the exemplary embodiments of the invention have been presented for purposes of illustration and description only. They are not intended to be exhaustive or to limit the invention to the precise forms disclosed, and modifications and variations are possible and contemplated in light of the above teachings. While a number of exemplary and alternate embodiments, methods, systems, configurations, and potential applications have been described, it should be understood that many variations and alternatives could be utilized without departing from the scope of the invention. For example, although it is mentioned that the film is moved through the imaging station, it is contemplated that the imaging station could be moved instead. In other words, movement of the film relative to the imaging station can be accomplished by moving the film and/or the imaging station. Moreover, although a variety of potential configurations and components have been described, it should be understood that a number of other configurations and components could be utilized without departing from the scope of the invention.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Accordingly, it is intended that the scope of the invention be defined by the claims appended hereto.

What is claimed is:

1. A method for creating a single digital image file from multiple scans, the method comprising:
scanning a first side of a medium using a single imaging station having only one sensor unit to create first digital data corresponding to a source image on the medium;
scanning an opposite side of the medium using the single imaging station to create second digital data corresponding to the source image; and
combining the first and second digital data to create a single digital image which represents the source image.

2. The method as recited in claim 1, wherein the medium comprises developing film, the steps are conducted for a first film development time to create the single digital image, the steps are repeated for a second film development time to create a second digital image representing the same source image, and the single digital image and the second digital image are combined to form an enhanced digital image representing the source image.

3. The method as recited in claim 1, wherein the imaging station comprises a pair of radiation sources configured to apply radiation to opposite sides of the medium.

4. The method as recited in claim 1, further comprising:
flipping the medium between the scanning steps.

5. The method as recited in claim 4, wherein the flipping is conducted automatically.

6. The method as recited in claim 4, wherein the flipping is conducted by introducing a twist into the medium.

7. The method as recited in claim 1, wherein the medium comprises developing film, the sensor unit is configured to record radiation reflected from the film and radiation transmitted through the film, and the imaging station comprises a back source configured to apply radiation to one side of the developing film and a front source configured to apply radiation to an opposite side of the developing film.

8. The method as recited in claim 1, further comprising:
aligning the first and second digital data.

9. A method for creating a digital image file from a developing film, comprising:
applying developer to film to cause the film to begin to develop;
moving the film relative to a scanning station having a single sensor unit during a first time period such that a front surface of the film faces the sensor unit;
during the first time period, applying radiation to a frame of the developing film;
sensing front radiation reflected from the frame during the first time period using the single sensor unit;
creating front digital data from the sensed front reflected radiation;
moving the film relative to the scanning station during a second time period such that a back surface of the film faces the single sensor unit, the back surface being opposite the front surface;
during the second time period, applying radiation to the frame;
sensing back radiation reflected from the frame during the second time period using the single sensor unit;
creating back digital data from the sensed back reflected radiation;
transmitting radiation through the frame;
sensing radiation transmitted through the film frame using the single sensor unit;
creating transmitted digital data from the sensed transmitted radiation; and
combining the front digital data, the back digital data, and the transmitted digital data to form a digital image file which represents the film frame.

10. The method as recited in claim 9, further comprising:
flipping the film.

11. The method as recited in claim 10, wherein the film is flipped by introducing a twist in the film and moving the twisted film.

12. The method as recited in claim 10, wherein the film is flipped manually.

13. The method as recited in claim 9, wherein the steps are conducted for a first film development time to create the digital image file, the steps are repeated for a second film development time to create a second digital image file, and the digital image file and the second digital image file are combined to form an enhanced digital image representing the frame.

14. The method as recited in claim 9, wherein the moving steps are conducted by moving the single sensor unit.

15. A digital film development system, comprising:
a source configured to apply radiation to a developing film strip;
a single sensor unit configured to sense radiation from the developing film strip; and
a transportation system adapted to pass the developing film strip in front of the single sensor unit multiple times such that opposite sides of the developing film strip face the sensor during each pass.

16. The system as recited in claim 15, wherein the sensor unit is configured to provide multiple digital data files for each frame on the film, each digital data file for the frame being created during a separate pass.

17. The system as recited in claim 16, further comprising:
an image processor configured to combine the digital data for each frame.

18. The system as recited in claim 17, wherein the image processor is configured to align the digital data for each frame.

19. The system as recited in claim 15, wherein the source comprises a back source configured to apply radiation to the one side of the film and a front source configured to apply radiation to an opposing side of the film.
